(19) United States
(12) Patent Application Publication
(10) Pub. No.: US 2014/0331163 A1
(43) Pub. Date: Nov. 6, 2014

(54) Method to Mark User Definable Limits

(71) Applicant: CATERPILLAR INC., Peoria, IL (US)

(72) Inventors: Fu Pei Yuet, Simpsonville, SC (US); Merritt Callaghan, Simpsonville, SC (US); Thomas M. Rowell, Greenville, SC (US)

(73) Assignee: Caterpillar Inc., Peoria, IL (US)

(21) Appl. No.: 13/887,829

(22) Filed: May 6, 2013

(51) Int. Cl. G06F 3/0488

(52) U.S. Cl. CPC G06F 3/0488
USPC 715/771

(57) ABSTRACT

A method of managing control of a drivetrain is provided. The method may include the steps of reading sensor data provided by one or more sensors configured to detect one or more operating parameters of the drivetrain, displaying one or more gauges on a touch screen device based on the sensor data, receiving one of a plurality of gestures through the touch screen device, and displaying one or more user definable limits for at least one of the gauges based on the gesture received where the user definable limits may be indicative of an operating threshold for at least one of the operating parameters of the drivetrain.

### TECHNICAL FIELD

The present disclosure generally relates to drivetrains, and more particularly, to methods and devices for providing user definable limits on drivetrain operations.

### BACKGROUND

Typical drivetrains associated with industrial machines, marine systems, and the like, provide a plurality of analog gauges by which a user or operator may monitor various operating parameters of the drivetrain. For example, analog gauges may be used to monitor fuel levels, drive speed, temperature, oil pressure, and the like. Conventional analog gauges may further indicate different thresholds or limits of operation that are reflective of predetermined limits of the drivetrain or associated machine. Moreover, an analog gauge may often use color-coded schemes to indicate the ranges or zones within which operation of the drivetrain is considered normal as well as ranges or zones within which operation is considered hazardous to the machine.

Over time, and as the drivetrain and associated machine age, these zones of operation may gradually deviate from those designated at the time of manufacture. As a result, operating a substantially aged drivetrain in strict accordance to default zones of operation as indicated by the analog gauges originally supplied with the drivetrain may produce inefficient or otherwise undesirable performance. Thus, operators understanding this gradual deviation in operational limits and having some familiarity with a particular drivetrain often handwrite markings onto the analog gauges so as to indicate the updated limits If and when the machine limits exhibit further deviations, the markings are typically erased and new markings are made on the analog gauges accordingly.

Although this method may help operators adapt to changes in the drivetrain over time, operators are still left to rely on their own cognizance of the changed limits and are without any safeguards in the event they forget to adjust machine control according to the handwritten markings. Additionally, other users or operators who may be unfamiliar with the markings and the machine may rely solely on the limits indicated by the original gauges, and thereby unintentionally allow the drivetrain to exceed its maximum limits. Furthermore, as warning indicators are only triggered by the less stringent, original thresholds and not by the stricter, updated thresholds of the drivetrain, an operator may be unaware that the drivetrain is operating beyond its ideal limits

The present disclosure is directed at addressing one or more of the needs set forth above.

### SUMMARY OF THE DISCLOSURE

In one aspect of the present disclosure, a method of managing control of a drivetrain is provided. The method may include the steps of reading sensor data provided by one or more sensors configured to detect one or more operating parameters of the drivetrain, displaying one or more gauges on a touch screen device based on the sensor data, receiving one of a plurality of gestures through the touch screen device, and displaying one or more user definable limits for at least one of the gauges based on the gesture received, the user definable limits being indicative of an operating threshold for at least one of the operating parameters of the drivetrain.

In another aspect of the disclosure, a method of providing a user definable limit on an operating parameter of a drivetrain is provided. The method may include the steps of displaying at least one gauge on a touch screen device corresponding to the operating parameter of the drivetrain, displaying the user definable limit and an associated timestamp on the gauge and setting the user definable limit to the current operating parameter detected if a first gesture is received through the touch screen device, and displaying the user definable limit and an associated timestamp on the gauge and setting the user definable limit to a user defined threshold indicated by the second gesture if a second gesture is received through the touch screen device.

In yet another aspect of the disclosure, a control panel for a drivetrain is provided. The control panel may include a touch screen device, and a controller in communication with the touch screen device and one or more sensors configured to detect one or more operating parameters of the drivetrain. The controller may be configured to display one or more gauges on the touch screen device based on sensor data, recognize one of a plurality of gestures received through the touch screen device, and display one or more user definable limits for at least one of the gauges based on the gesture, where the user definable limits may be indicative of an operating threshold for at least one of the operating parameters of the drivetrain.

### BRIEF DESCRIPTION OF THE DRAWINGS

FIG. 1 is a diagrammatic view of one machine having a drivetrain and a control panel constructed in accordance with the teachings of the present disclosure;

FIG. 2 is a schematic view of one exemplary embodiment of a touch screen device of a drivetrain control panel; and

FIG. 3 is a diagrammatic view of one exemplary method of providing user definable limits on operating parameters of a drivetrain.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

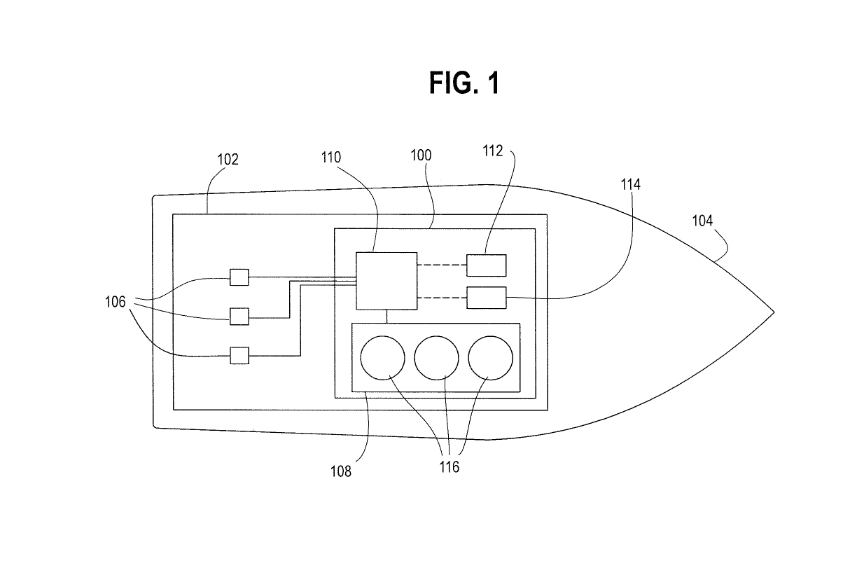

With reference to FIG. 1, one exemplary embodiment of a control panel 100 for a drivetrain 102 of a machine 104 is diagrammatically illustrated. The machine 104 may include a marine vessel, or any other mobile machine for transporting passengers, goods, and the like. The machine 104 may also include a work vehicle that performs some type of operation associated with a particular industry such as mining, construction, farming, transportation, and the like, and operates between or within work environments, such as construction sites, mine sites, power plants, on-highway applications, marine applications, and the like. The machine 104 may include any type of automobile or commercial vehicle, such as on-highway vehicles, commercial trucks, cranes, earthmoving vehicles, mining vehicles, backhoes, loaders, material handling equipment, farming equipment, aircraft, and any type of movable machine. The machine 104 may also include industrial machines or tools, such as pumps, drilling tools, or any other suitable machine or tool which may incorporate a drivetrain.

As shown in FIG. 1, the control panel 100 may communicate with one or more sensors 106 distributed about the drivetrain 102 and configured to detect one or more operating parameters of the drivetrain 102. More specifically, the sensors 106 may be configured to detect fuel level, engine speed, engine temperature, oil pressure, and the like. In a machine 104 being incorporated as a marine vessel, for example, the sensors 106 may be configured to detect fuel level, port-side engine speed, port-side engine temperature, port-side oil pressure, as well as starboard-side engine speed, starboard-side engine temperature, starboard-side oil pressure, and the like. Upon capturing relevant sensor data from the drivetrain 102, the sensors 106 may electronically communicate the sensor data to the control panel 100 for further analysis.

The control panel 100 of FIG. 1 may generally include a touch screen device 108 and a controller 110 that is in communication with one or more of the sensors 106 and the touch screen device 108. The controller 110 may be implemented using any one or more of a processor, a microprocessor, a microcontroller, a digital signal processor (DSP), a field-programmable gate array (FPGA), an electronic control module (ECM), an electronic control unit (ECU), or any other suitable means for managing operation of the control panel 100, drivetrain 102, the associated machine 104, the sensors 106 and/or the touch screen device 108. Optionally or additionally, the control panel 100 may include a memory 112, such as flash memory, with which the controller 110 may communicate to retrieve various data, algorithms, instruction code, or the like, or retrievably store various sensor data or other information pertaining to the drivetrain 102 and the machine 104. In addition, the control panel 100 may optionally include a communication device 114 which employs any one of a variety of different protocols for communicating information, over wired and/or wireless means, between the controller 110 and other computational and/or mobile devices that may be remote from the control panel 100.

Still referring to FIG. 1, the touch screen device 108 may be implemented as a human interface device or user interface through which information may be communicated between the drivetrain 102 and an operator or user. Moreover, the touch screen device 108 may serve as a display or an output device for displaying various operating parameters of the drivetrain 102 to a user, as well as an input device for receiving various instructions, commands or other user input for controlling the drivetrain 102 or operations thereof. The touch screen device 108 may be configured to present any one of a variety of display screens to a user, and further, enable the user to make viewing selections, modify views, edit information, enter data or commands, and the like, via touch input or gestures. For example, by default or at the request of the user, the touch screen device 108 may be configured by the controller 110 to electronically display gauges 116 thereon indicating essentially real-time or current operating parameters of the drivetrain 102 as detected by the associated sensors 106. At the request of the user, the touch screen device 108 may also display a graphical keypad, keyboard, or the like, through which the user may input information, data and/or commands. In addition, the touch screen device 108 may provide graphical machine controls which the user may use to control the drivetrain 102 and/or the machine 104.

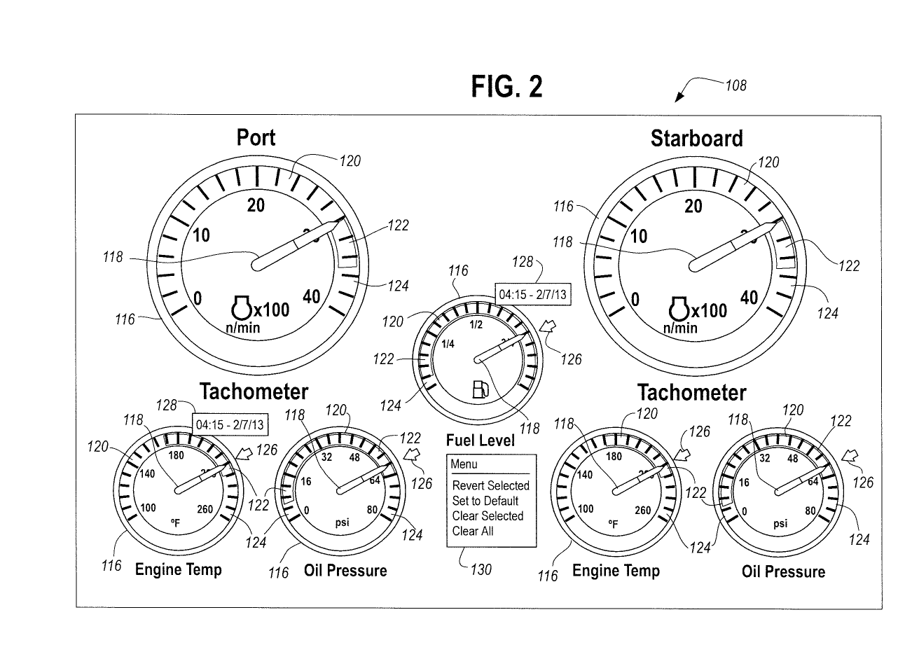

Turning to FIG. 2, one exemplary embodiment of view of the touch screen device 108 is displayed. As shown, the touch screen device 108 may display one or more gauges 116 displaying one or more operating parameters of the associated drivetrain 102. For example, the touch screen device 108 may graphically display a fuel level gauge, tachometers, temperature gauges, pressure gauges, and any other operating parameter of the drivetrain 102 that may be relevant to the user. Moreover, each of the gauges 116 may take the appearance of analog-type gauges having a gauge needle 118, and further, depict one or more thresholds thereon. For example, each gauge 116 may comprise a color-coded scheme depicting a normal operating zone 120, a warning zone 122, a hazard/shutdown zone 124, and the like. The normal operating zone 120 may indicate ideal operating parameters of the drivetrain 102, whereas the warning zone 122 and hazard zone 124 may correspond to maximum or minimum operating thresholds that should be avoided and not exceeded by the drivetrain 102. It will be understood that any other type of gauge design may be implemented in the views displayed by the touch screen device 108, and any scheme other than color-coded schemes may be implemented in depicting the thresholds. Furthermore, other thresholds, such as lower-limit thresholds, and other operating zones may also be indicated in any of the gauges 116.

The respective thresholds for each of the operating zones 120, 122, 124 shown in FIG. 2 may be preset values that are preprogrammed within the controller 110 and displayed on the gauges 116 by default. Additionally, the controller 110 may be programmed to automatically trigger an audible indicator and/or a visual indicator to alert or warn the user of certain undesirable operating conditions of the drivetrain 102. For example, if the gauge needle 118 in any of the gauges 116 enters into the warning zone 122 or the hazard zone 124, the controller 110 may be configured to engage any one or more of a buzzer, a siren, lighting mechanisms, and the like, to signal such operating conditions to the user. Optionally, the controller 110 may also employ the communication device 114 to transmit an automated message, notification, alert, or the like, over wired or wireless networks and to inform the appropriate recipients of the condition or event.

Over time, and as the drivetrain 102 ages, the actual operating limits of the drivetrain 102 may deviate from the default thresholds presented on each of the gauges 116. With reference to the oil pressure gauge 116 in FIG. 2, for example, the critical oil pressure or oil pressure threshold corresponding to the hazard zone 122 may have deviated from the default threshold of 64 psi to 60 psi. Under such conditions, if the oil pressure of the drivetrain 102 reaches, for instance 62 psi, the maximum threshold of the drivetrain 102 will have been exceeded without being made known to a user viewing the gauge 116 and without signaling any warnings or alerts. Although certain operators or users with a particular familiarity with the drivetrain 102 may be aware of these threshold deviations and the altered limits of the drivetrain 102, there may not be adequate means to ensure these altered limits are made known to other users or to prevent the drivetrain 102 from exceeding such limits in the future. Even if extra measures of caution are exercised, as the thresholds will likely continue to deviate over time, it may prove to be cumbersome to appropriately and promptly accommodate for the continuing deviations. Thus, the control panel 100 and the controller 110 thereof may be configured to enable the user to easily set and update user definable limits 126 on any one or more of the graphical gauges 116 of the touch screen device 108.

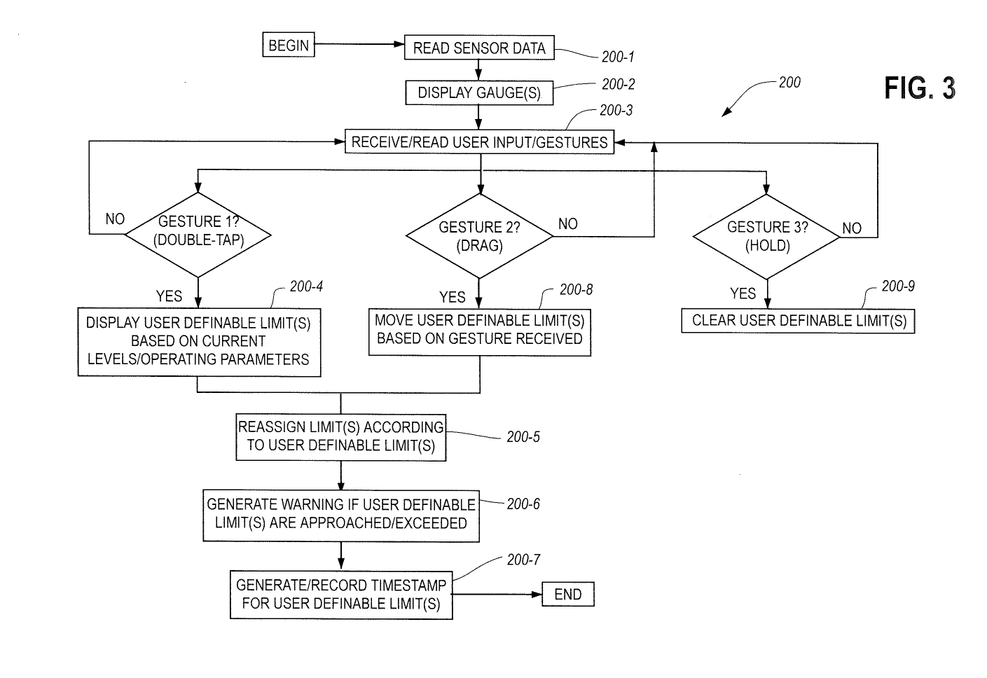

With reference to FIG. 3, for instance, one exemplary method 200 or algorithm by which the controller 110 of the control panel 100 may be configured to manage control of an associated drivetrain 102 is diagrammatically provided. More specifically, the algorithm or set of instructions may be preprogrammed or incorporated into the memory 112, or any other memory that is otherwise accessible by the controller 110, and configure the controller 110 to enable user definable limits 126 on one or more operating parameters of the associated drivetrain 102. As shown, in an initial or base step 200-1, the controller 110 may be configured to read sensor data communicated by one or more sensors 106 that are configured to detect one or more operating parameters of the associated drivetrain 102. Moreover, the controller 110 may continuously collect sensor data from the relevant sensors 106 in the form of repeated iterations or cycles, for example, at a substantially high rate or frequency. Once sensor data is captured for a particular iteration, the controller 110 may display the one or more gauges 116 corresponding to the captured sensor data on the touch screen device 108 in step 200-2. Furthermore, per iteration of data capture in step 200-1, the controller 110 may be configured to update the gauges 116 displayed on the touch screen device 108 to reflect any detected changes in the operating parameters of the drivetrain 102 in step 200-2.

As shown in FIG. 3, the controller 110 may be configured to receive any input from the user in step 200-3. More specifically, the controller 110 may be preprogrammed to read or recognize any touch input, gesture input, or combinations thereof, which may be received from the user through the touch screen device 108, and to associate each combination of inputs or gestures with a user request or command to perform a different function or task. In the embodiment shown in FIG. 3, the controller 110 may be configured to receive and recognize, for example, at least three different gestures, such as a double-tap gesture, a drag gesture and a hold gesture. In other modifications, the controller 110 may be similarly programmed to recognize other types of touch inputs and/or gestures, such as swiping, single-tapping, multi-tapping, multi-finger indexing, multi-finger swiping, palm swiping, pinching, spreading, and the like. It will be understood that other combinations of touch input and gestures, as well as functions or tasks corresponding thereto, will be apparent to those skilled in the art without departing from the scope of the appended claims.

According to the flow diagram of FIG. 3, if the controller 110 recognizes a double-tap gesture to be received from a user through the touch screen device 108 in step 200-3, the controller 110 may configure the touch screen device 108 to graphically display markers indicating user definable limits 126 relative to the gauges 116 as shown in FIG. 2. More specifically, in response to the double-tap gesture, the controller 110 may be configured to set the user definable limits 126 according to the immediate or current operating parameters, as detected by the sensors 106 in that iteration and as indicated by the gauge needles 118 at the time the double-tap gesture was received from the user. If no further input or adjustment is received from the user for a predefined duration of time, the controller 110 may be configured to accept the user definable limits 126 established during step 200-4 as the desired thresholds of the drivetrain 102. In particular, in step 200-5, the controller 110 may reassign existing, default limits or thresholds of the drivetrain 102 to the newly defined user definable limits 126 shown in FIG. 2. Alternatively, the controller 110 may implement other means of confirming the change or finalizing the newly set user definable limits 126. Additionally or optionally, the controller 110 in step 200-6 may also be reconfigured to generate threshold warnings, alerts and/or notifications according to the newly assigned user definable limits 126 rather than the default or original thresholds thereof.

In an additional step 200-7, the controller 110 may also be configured to automatically generate a timestamp 128 associated with the new user definable limits 126. More specifically, for each new or modified user definable limit 126, the controller 110 may automatically record the time the change was made, the date the change was made, the user login of implementing the change, the drivetrain 102 and/or machine 104 to which the change was directed, or any other information that may be of relevance to users or operators of the drivetrain 102. Moreover, as shown in FIG. 2 for example, each timestamps 128 may be displayed proximate to the relevant user definable limit 126 and/or gauge 116 on the touch screen device 108. Based on user preferences or the default settings provided, the timestamps 128 may be continuously displayed, or normally hidden from view and temporarily displayed upon user request or interaction via the touch screen device 108. Furthermore, any or all data recorded in obtaining the timestamp 128 may be stored or logged in a memory 112 associated with the controller 110 so as to be retrievable at any time by the appropriate users, operators, engineers, and the like.

If, however, the controller 110 during step 200-3 of FIG. 3 recognizes a drag or a tap-then-drag gesture that is received from a user through the touch screen device 108, the controller 110 may configure the touch screen device 108 to graphically adjust, move or reposition the user definable limits 126 as desired by the user. Specifically, the controller 110 in step 200-8 may enable the marker graphics corresponding to the user definable limits 126 to follow the drag gesture being input by the user until the user ends the drag gesture and disengages with the touch screen device 108. In contrast to step 200-4, the controller 110 in step 200-8 thereby enables the user to set the user definable limits 126, or the new limits of the operating parameters of the drivetrain 102, as desired and without regard to the currently detected operating parameters. If no further input or adjustment is received from the user for a predefined duration of time, the controller 110 may be configured to accept the user definable limits 126 established during step 200-8 as the desired thresholds of the drivetrain 102. In particular, in step 200-5, the controller 110 may reassign the existing, default limits or thresholds of the drivetrain 102 to the newly defined user definable limits 126 shown in FIG. 2. In other alternatives, the controller 110 may implement other means of confirming the change or finalizing the newly set user definable limits 126. Additionally or optionally, the controller 110 in step 200-6 may also be reconfigured to generate threshold warnings, alerts and/or notifications according to the newly assigned user definable limits 126 rather than the default or original thresholds thereof. Furthermore, the controller 110 in step 200-7 may generate timestamps 128 associated with the new user definable limits 126 to be displayed on the touch screen device 108 and/or retrievably stored within a memory 112 associated with the controller 110.

Still referring to FIG. 3, the controller 110 may additionally be configured to recognize a third gesture, such as a hold or a tap-then-hold gesture, during step 200-3. If the controller 110, at any time during operation of the control panel 100 and associated drivetrain 102, recognizes such a hold gesture input into the touch screen device 108 by a user, the controller 110 may be configured to clear any of the markers corresponding to the user definable limits 126 presently displayed in relation to the gauges 116 of the touch screen device 108 in step 200-8. Alternatively, the controller 110 may be configured to reset the positions of the user definable limits 126 to a previously defined position or a default position. In other modifications, the controller 110 may be configured to enable the user to clear or reset any one or more existing markers corresponding to the user definable limits 126 in a selective manner. For example, the controller 110 may be configured such that tapping and holding one marker clears only the marker selected and leaves all other markers in their respective positions. In still further alternatives, the controller 110 may respond to a gesture by displaying a temporary or pop-up menu 130, as shown for example in FIG. 2, which provides the user with more specific options, such as reverting the selected user definable limit 126 to a prior setting, setting the selected user definable limit 126 to default, clearing only the selected user definable limit 126, clearing all of the user definable limits 126, and/or any other suitable option. Other combinations of gestures and corresponding effects will be apparent to those skilled in the art.

### INDUSTRIAL APPLICABILITY

In general, the foregoing disclosure finds utility in various applications relating to control systems for vehicles, machines, tools, and any other suitable device implementing a drivetrain, such as marine vessels, mobile machines, work vehicles, on-highway vehicles, commercial trucks, cranes, earthmoving vehicles, mining vehicles, backhoes, loaders, material handling equipment, farming equipment, aircraft, industrial machines or tools, such as pumps, drilling tools, and the like.

Specifically, the disclosed devices and methods may be used to provide efficient means of enabling user defined limits or thresholds on one or more operating parameters of a drivetrain while providing added functionality. In such a way, the present disclosure serves not only to facilitate user control and management of drivetrain operating parameters and improve functionality thereof, but also serves to replace the analog gauges of conventional control panels and inconsistencies associated therewith.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A method of managing control of a drivetrain, comprising the steps of:
reading sensor data provided by one or more sensors configured to detect one or more operating parameters of the drivetrain;
displaying one or more gauges on a touch screen device based on the sensor data;
receiving one of a plurality of gestures through the touch screen device; and
displaying one or more user definable limits for at least one of the gauges based on the gesture received, the user definable limits being indicative of an operating threshold for at least one of the operating parameters of the drivetrain.

2. The method of claim 1, wherein the gestures include one or more of a first gesture configured to set the user definable limit according to current operating parameters of the drivetrain, a second gesture configured to set the user definable limit according to a user defined threshold, and a third gesture configured to clear one or more of the user definable limits from one or more of the gauges.

3. The method of claim 2, wherein the first gesture corresponds to a double-tap gesture, the second gesture corresponds to a drag gesture, and the third gesture corresponds to a hold gesture.

4. The method of claim 1, further comprising the steps of generating timestamp data for each user definable limit, and retrievably storing the timestamp data within a memory.

5. The method of claim 1, wherein the drivetrain is a marine drivetrain and the gauges display one or more of a fuel level gauge, a port-side tachometer, a port-side engine temperature gauge, a port-side oil pressure gauge, a starboard-side tachometer, a starboard-side engine temperature gauge, and a starboard-side oil pressure gauge.

6. The method of claim 1, wherein the gauges indicate one or more default operating zones therein, the default operating zones including one or more of a normal operating zone, a warning zone, and a hazard/shutdown zone, the user definable limits being configured to modify one or more limits of the default operating zones according to user input.

7. The method of claim 1, further comprising the step of enabling one or more of an audible indicator and a visual indicator such that a user is notified when the operating parameters of the drivetrain exceed one or more of the user definable limits

8. A method of providing a user definable limit on an operating parameter of a drivetrain, comprising the steps of:
displaying at least one gauge on a touch screen device corresponding to the operating parameter of the drivetrain;
if a first gesture is received through the touch screen device, displaying the user definable limit and an associated timestamp on the gauge and setting the user definable limit to the current operating parameter detected; and
if a second gesture is received through the touch screen device, displaying the user definable limit and an associated timestamp on the gauge and setting the user definable limit to a user defined threshold indicated by the second gesture.

9. The method of claim 8, further comprising the step of, if a third gesture is received through the touch screen device, clearing the user definable limit from the touch screen device.

10. The method of claim 9, wherein the first gesture corresponds to a double-tap gesture, the second gesture corresponds to a drag gesture, and the third gesture corresponds to a hold gesture.

11. The method of claim 8, wherein the gauge displays any one or more of a fuel level gauge, a tachometer, a temperature gauge, and an oil pressure gauge.

12. The method of claim 8, wherein the gauge indicates one or more default operating zones therein, the default operating zones including one or more of a normal operating zone, a warning zone, and a hazard/shutdown zone, the user definable limit being configured to modify one or more limits of the default operating zones according to user input.

13. The method of claim 8, further comprising the steps of enabling one or more of an audible indicator and a visual indicator such that a user is notified when the detected operating parameter of the drivetrain exceeds the user definable limit, and retrievably storing data pertaining to the timestamps for each user definable limit displayed.

14. A control panel for a drivetrain, comprising:
a touch screen device; and
a controller in communication with the touch screen device and one or more sensors configured to detect one or more operating parameters of the drivetrain, the controller being configured to display one or more gauges on the touch screen device based on sensor data, recognize one of a plurality of gestures received through the touch screen device, and display one or more user definable limits for at least one of the gauges based on the gesture, the user definable limits being indicative of an operating threshold for at least one of the operating parameters of the drivetrain.

15. The control panel of claim 14, wherein the controller is configured to recognize one or more of a first gesture, a second gesture and a third gesture, the controller being configured to set the user definable limit according to current operating parameters of the drivetrain in response to the first gesture, set the user definable limit to a user defined threshold in response to the second gesture, and clear one or more of the user definable limits from one or more of the gauges in response to the third gesture.

16. The control panel of claim 15, wherein the controller is configured to recognize the first gesture as a double-tap gesture, recognize the second gesture as a drag gesture, and recognize the third gesture as a hold gesture.

17. The control panel of claim 14, wherein the controller is additionally configured to generate timestamp data for each user definable limit, and retrievably store the timestamp data within a memory associated therewith.

18. The control panel of claim 14, wherein the drivetrain is a marine drivetrain and the controller configures the gauges to display one or more of a fuel level gauge, a port-side tachometer, a port-side engine temperature gauge, a port-side oil pressure gauge, a starboard-side tachometer, a starboard-side engine temperature gauge, and a starboard-side oil pressure gauge.

19. The control panel of claim 14, wherein the controller configures the gauges to indicate one or more default operating zones therein, the default operating zones including one or more of a normal operating zone, a warning zone, and a hazard/shutdown zone, the controller being configured to modify one or more limits of the default operating zones according to the user definable limits

20. The control panel of claim 14, wherein the controller is configured to further enable one or more of an audible indicator and a visual indicator so as to notify a user when the operating parameters of the drivetrain exceed one or more of the user definable limits.
